(19) United States
(12) Patent Application Publication
(10) Pub. No.: US 2022/0034523 A1
(43) Pub. Date: Feb. 3, 2022

(54) OPEN-TYPE CEILING REFRIGERATION SYSTEM

(71) Applicant: Wuyi University, Jiangmen City (CN)

(72) Inventor: Min Wu, Jiangmen City (CN)

(21) Appl. No.: 17/320,472

(22) Filed: May 14, 2021

(30) Foreign Application Priority Data
Jul. 29, 2020 (CN) 2020107452128

(51) Int. Cl. F24F 1/0047; F24F 13/22; F24F 1/0059

(52) U.S. Cl. CPC F24F 1/0047; F24F 1/0059; F24F 13/222

(57) ABSTRACT

An open-type ceiling refrigeration system is disclosed, including a ceiling, an evaporation pipe fixedly connected to the ceiling and slantly arranged, a water inlet pipe, and a water removal assembly for absorbing water vapor. An output end of the water inlet pipe is connected to the input end of the evaporation pipe, and the water inlet pipe is connected to a three-way valve; and the water removal assembly is located below the evaporation pipe and includes a water sealing cavity, the output end of the evaporation pipe is connected to the water sealing cavity by means of a recovery pipe, the water sealing cavity is connected to a first pipeline extending upwards and communicated with the input end of the evaporation pipe, a lower end of the first pipeline is connected to a molecular sieve for limiting water vapor from passing through.

### CROSS-REFERENCE TO RELATED APPLICATIONS

This application is based on and claims the benefit of priority from Chinese Patent Application No. 2020107452128, filed on 29 Jul. 2020, the entirety of which is incorporated by reference herein.

### TECHNICAL FIELD

The present disclosure relates to the field of indoor refrigeration technologies, and in particular, to an open-type ceiling refrigeration system.

### BACKGROUND

Current indoor refrigeration generally relates to mounting a conventional air conditioner, such as a central air conditioner and a cabinet air conditioner. Refrigeration technology adopted thereby is only to apply a compressor to compress a refrigerant into liquid, and transport the liquid to an evaporator. The refrigerant in a liquid state volatilizes to take away heat, so as to lower the temperature of the evaporator to implement cooling. However, this refrigeration technology has high production cost, and is not environmentally friendly as it adopts an environmentally harmful refrigerant such as Freon.

### SUMMARY

The present disclosure aims at solving at least one of technical problems existing in the prior art. With this regard, the present disclosure provides an open-type ceiling refrigeration system, which uses water for heat absorption and evaporation to implement refrigeration, thereby having a low cost and being environmentally friendly.

An open-type ceiling refrigeration system according an embodiment of the present disclosure includes a ceiling; an evaporation pipe fixedly connected to the ceiling and slantly arranged, an input end of the evaporation pipe being higher than an output end of the evaporation pipe; a water inlet pipe disposed outside the ceiling, an output end of the water inlet pipe being connected to the input end of the evaporation pipe, and the water inlet pipe being connected to a three-way valve; and a water removal assembly disposed outside the ceiling and below the evaporation pipe, the water removal assembly comprising a water sealing cavity, the output end of the evaporation pipe being connected to the water sealing cavity by means of a recovery pipe, the water sealing cavity being connected to a first pipeline extending upwards and communicated with the input end of the evaporation pipe, a lower end of the first pipeline being connected to a molecular sieve configured for limiting water vapor from passing through, and the water removal assembly being configured for absorbing the water vapor.

The technical solution above has at least the following beneficial effects. By fixedly connecting the evaporation pipe to the ceiling, extracting air in the evaporation pipe from the three-way valve to form vacuum and filling hydrogen into the evaporation pipe, a zero partial pressure of the water vapor in the evaporation pipe can be formed. Then the water inlet pipe provides liquid water into the evaporation pipe, the liquid water can absorb heat to be evaporated as the partial pressure of the water vapor in the evaporation pipe is zero, and exchanges heat with ambient air thereof (for example, indoor) by means of the evaporation pipe, so as to implement indoor refrigeration. Since the evaporation pipe is slantly arranged towards the output end, the liquid water flows towards the output end of the evaporation pipe while continuously absorbing heat for evaporation to continuously perform indoor refrigeration. After the water is evaporated, the volume of gas in the evaporation pipe is expanded, and the pressure is increased, driving the gas to move towards the water sealing cavity by means of the recovery pipe. After the gas reaches the water sealing cavity, the water vapor gradually trends from an unsaturated state to a supersaturated state, and redundant water vapor is condensed into liquid water in the water sealing cavity, while hydrogen moves upwards by means of the molecular sieve and the first pipeline and enters the evaporation pipe for executing a next refrigeration circulation, implementing continuous refrigeration. In this way, refrigeration can be achieved by using water for heat absorption and evaporation, which has a low production cost. Moreover, no environmentally harmful refrigerant such as Freon is used, and thus it is environmentally friendly.

According to some embodiments of the present disclosure, an inclined angle of the input end of the evaporation pipe towards the output end of the evaporation pipe is 2° to 10°.

According to some embodiments of the present disclosure, a water absorption fiber is disposed in the evaporation pipe.

According to some embodiments of the present disclosure, the evaporation pipe is an S-shaped bent pipe.

According to some embodiments of the present disclosure, the evaporation pipe is a copper pipe, a stainless steel pipe, or a thin-walled plastic pipe.

According to some embodiments of the present disclosure, the water removal assembly includes a first water tank and a second water tank, the first water tank is placed in the second water tank, the second water tank has an upper opening, the second water tank is connected to the input end of the water inlet pipe by means of a third pipeline, the third pipeline is connected to a first switch valve, a lower end of the first water tank is provided with a lower opening communicating the first water tank with the second water tank, the lower opening is connected to a second switch valve, and the first water tank has a water sealing cavity.

According to some embodiments of the present disclosure, a top of the second water tank is provided with a shading tent.

According to some embodiments of the present disclosure, an input end of the water inlet pipe is connected to a third switch valve.

According to some embodiments of the present disclosure, the water inlet pipe is connected to a U-shaped bent pipe, and the U-shaped bent pipe is located at a lower side of the water inlet pipe.

According to some embodiments of the present disclosure, the open-type ceiling refrigeration system further includes a hydrogen production means; the hydrogen production means includes a third water tank, an anode block, a cathode block, a collection cover, and an external DC power source; the third water tank stores a hydrogen production electrolyte; the anode block and the cathode block are disposed in the third water tank at an interval; the anode block is connected to a positive pole of the external DC power source; the cathode block is connected to a negative pole of the external DC power source; the collection cover covers above the cathode block; the collection cover is connected to the water sealing cavity by means of a second pipeline; and the second pipeline is provided with a fourth switch valve.

Additional aspects and advantages of the present disclosure will be given in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible in the description of embodiments made with reference to the following accompanying drawings, wherein:

FIG. 1 is a schematic structural diagram of an open-type ceiling refrigeration system according to an embodiment of the present disclosure;

FIG. 2 is a sectional view of an evaporation pipe according to an embodiment of the present disclosure; and

FIG. 3 is a top view of an evaporation pipe according to an embodiment of the present disclosure.

List of reference numerals

| | |
|---|---|
| Ceiling | 100 |
| U-shaped pipe clamp | 110 |
| evaporation pipe | 200 |
| recovery pipe | 210 |
| water absorption fiber | 220 |
| water inlet pipe | 300 |
| three-way valve | 310 |
| third switch valve | 320 |
| U-shaped bent pipe | 330 |
| water removal assembly | 400 |
| first pipeline | 410 |
| molecular sieve | 411 |
| first water tank | 420 |
| water sealing cavity | 421 |
| lower opening | 422 |
| second switch valve | 423 |
| second water tank | 430 |
| upper opening | 431 |
| third pipeline | 432 |
| first switch valve | 433 |
| shading tent | 434 |
| hydrogen production means | 500 |
| third water tank | 510 |
| anode block | 520 |
| cathode block | 530 |
| collection cover | 540 |
| external DC power source | 550 |
| second pipeline | 560 |
| fourth switch valve | 561 |

### DETAILED DESCRIPTION

This part will describe specific embodiments of the present disclosure in detail. Preferable embodiments of the present disclosure are shown in the accompanying drawings. The accompanying drawings are provided for the purpose of supplementing the written description with graphics, so that each technical feature and the entire technical solution of the present disclosure can be visually and figuratively understood by those having ordinary skill in the art, but they cannot be understood as limitation to the scope of protection of the present disclosure.

In the description of the disclosure, it should be understood that the positional descriptions referred to, for example, the directional or positional relationships indicated by up, down, front, rear, left, right, etc., are based on the directional or positional relationships shown in the drawings, and are only for convenience and simplification of description of the disclosure, but not for indicating or implying that the referred device or element must have a specific direction, be constructed and operated in a specific direction, and thus should not be construed as limiting the disclosure

In the description of the disclosure, “certain” means one or more, “a plurality of” means two or more, and “greater than”, “less than”, “more than”, etc. are understood as excluding the number itself, “above”, “below”, “within”, etc. are understood as including the number itself. “First”, “second”, etc., if referred to, are for the purpose of distinguishing technical features only, cannot be understood as indicating or implying a relative importance or implicitly indicating the number of technical features indicated or implicitly indicating the precedence of technical features indicated.

In the description of the disclosure, unless otherwise clearly defined, terms such as “arrange”, “mount”, “connect” should be understood in a broad sense, and those skilled in the art can reasonably determine the specific meanings of the above terms in the disclosure by combining the specific contents of the technical solutions.

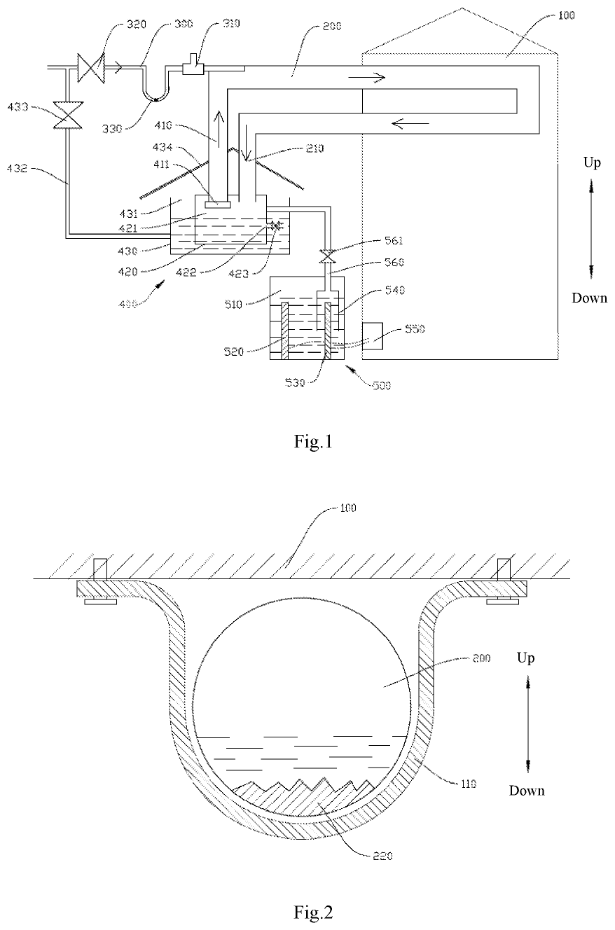

Referring to FIG. 1 and FIG. 2, the embodiment of the present disclosure provides an open-type ceiling refrigeration system, including a ceiling 100, an evaporation pipe 200 fixedly connected to the ceiling 100 by means of a U-shaped pipe clamp 110 for evaporation and heat absorption. The evaporation pipe 200 is slantly arranged, an input end of the evaporation pipe 200 is higher than an output end of the evaporation pipe 200, for facilitating automatic flow of liquid water towards the output end of the evaporation pipe 200. The input end of the evaporation pipe 200 is connected to a water inlet pipe 300. The water inlet pipe 300 is disposed outside the ceiling 100 and is configured for inputting the liquid water into the evaporation pipe 200. An output end of the water inlet pipe 300 is inserted into the evaporation pipe 200. The water inlet pipe 300 is provided with a three-way valve 310 for extracting air in the evaporation pipe 200 to form vacuum. The open-type ceiling refrigeration system further includes a water removal assembly 400 disposed outside the ceiling 100 and located below the evaporation pipe 200. The water removal assembly 400 is configured for absorbing water vapor. Specifically, the water removal assembly 400 includes a first water tank 420 and a second water tank 430. The first water tank 420 is placed in the second water tank 430. The second water tank 430 has an upper opening 431 and is communicated with outside to facilitate heat exchange with the outside. The first water tank 420 has a lower opening 422 at a lower end of a sidewall, which communicates the first water tank 420 with the second water tank 430. The lower opening 422 is provided with a second switch valve 423 to facilitate controlling the flow rate of water. The second water tank 430 is connected to an input end of the water inlet pipe 300 by means of a third pipeline 432 and injects a small amount of liquid water into the second water tank 430 to cover the lower opening 422, so that a water sealing cavity 421 is formed at an upper part of the first water tank 420. The third pipeline 432 is provided with a first switch valve 433 to facilitate controlling the flow rate of the water. An upper end of the water sealing cavity 421 is connected to the output end of the evaporation pipe 200 by means of a recovery pipe 210. The upper end of the water sealing cavity 421 is further connected with a first pipeline 410 extending upwards and communicated with the input end of the evaporation pipe 200. A lower end of the first pipeline 410 is connected to a molecular sieve 411 which only allows hydrogen to pass through and limits water vapor from passing through. The refrigeration system further includes a hydrogen production means 500 disposed outside the ceiling 100. The hydrogen production means 500 is connected to the water sealing cavity 421 by means of a second pipeline 560 and is configured for producing and introducing hydrogen with high purity into the evaporation pipe 200, so as to provide a stable hydrogen source. The hydrogen with high purity ensures a good refrigeration effect. Specifically, the hydrogen production means 500 includes a third water tank 510, an anode block 520, a cathode block 530, a collection cover 540, and an external DC (direct current) power source 550. The anode block 520 is provided as a carbon rod and the cathode block 530 is provided as an iron rod. The third water tank 510 stores a hydrogen production electrolyte which may be an unsaturated sodium chloride solution. The carbon rod and the iron rod are disposed in the third water tank 510 at an interval and are immersed in the unsaturated sodium chloride solution. The carbon rod is connected to a positive pole of the external DC power source 550, the iron rod is connected to a negative pole of the external DC power source 550. The external DC power source 550 may be obtained by rectifying a common household power source. According to a chemical reaction equation

$$NaCl + {H}_{2} O {\to }^{energizing} NaClO + {H}_{2} ↑ ,$$

hydrogen can be produced and escapes at the iron rod. The collection cover 540 covers above the iron rod for collecting produced hydrogen. A top of the collection cover 540 is connected to an end of the second pipeline 560 and the other end of the second pipeline 560 is connected to the water sealing cavity 421, so as to provide a stable hydrogen source for the evaporation pipe 200. The second pipeline 560 is provided with a fourth switch valve 561 for controlling the flow rate of hydrogen.

The evaporation pipe 200 may fixedly connected to the ceiling 100 to maintain indoor beauty. When the refrigeration system operates, air in the evaporation pipe 200 is first extracted from the three-way valve 310 to form vacuum, and hydrogen is produced by means of the hydrogen production means 500 to be filled into the evaporation pipe 200. The intensity of pressure of hydrogen in the evaporation pipe 200 is set to one atmospheric pressure. At this time, a partial pressure of the water vapor in the evaporation pipe 200 is zero, and the water inlet pipe 300 provides liquid water into the evaporation pipe 200. According to the national water supply code, the pressure of the liquid water is greater than one atmospheric pressure. Since the partial pressure of the water vapor in the evaporation pipe 200 is zero, the liquid water absorbs heat to be evaporated and exchanges heat with ambient air thereof (e.g., indoor) by means of the evaporation pipe 200, so as to implement the indoor refrigeration. Since the evaporation pipe 200 is slantly arranged towards the output end, the liquid water flows towards the output end of the evaporation pipe 200 and continuously absorbs heat for evaporation to continue indoor refrigeration. After the water is evaporated, the volume of mixed gases of hydrogen and water vapor in the evaporation pipe 200 is expanded, and the pressure is increased, driving the mixed gases to move towards the water sealing cavity 421 by means of the recovery pipe 210. After the mixed gases reach the water sealing cavity 421, the water vapor in the mixed gases in the water sealing cavity 421 gradually trends from an unsaturated state to a supersaturated state. Redundant water vapor is condensed into liquid water in the water sealing cavity 421. The liquid water exchanges heat with the outside by means of the upper opening 431 of the second water tank 430, for dissipating heat. Hydrogen then moves upwards by means of the molecular sieve 411 and the first pipeline 410 and enters the evaporation pipe 200 for executing a next refrigeration circulation, implementing continuous refrigeration. In this way, refrigeration can be achieved by using water for heat absorption and evaporation without setting a compressor, which has a low production cost and low power consumption. Moreover, no environmentally harmful refrigerant such as Freon is used, and thus it is environmentally friendly.

In some embodiments, an inclined angle of the input end of the evaporation pipe 200 towards the output end of the evaporation pipe 200 is 2° to 10°, and preferably, 2°. This inclined angle enables the liquid water to gradually flow towards the output end of the evaporation pipe 200 and slow down the flow of the liquid water to avoid missing evaporation due to rapid flowing of the liquid water. The entire evaporation pipe 200 is provided with the liquid water for heat absorption and evaporation, so that the evaporation pipe 200 fully exchanges heat with the indoor air, to ensure the refrigeration effect.

Referring to FIG. 2, in some embodiments, a water absorption fiber 220 is disposed at a lower part in the evaporation pipe 200. As can be seen from the sectional view of the evaporation pipe 200, the water absorption fiber 220, liquid water, and hydrogen are shown successively in the evaporation pipe 200 from bottom to top. The water absorption fiber 220 can effectively lower the flow rate of the liquid water so that the liquid water in the evaporation pipe 200 can fully absorb heat to be evaporated and the evaporation pipe 200 can fully exchange heat with the indoor air, to ensure the refrigeration effect.

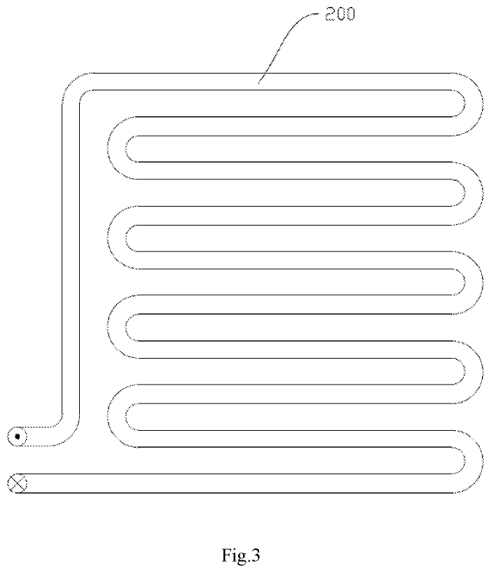

Referring to FIG. 3, in some embodiments, the evaporation pipe 200 is provided as an S-shaped bent pipe, which can increase a contact area between the evaporation pipe 200 and the indoor air, enlarge an area for heat exchange, and accelerate the speed for indoor refrigeration.

In some embodiments, the evaporation pipe 200 is a copper pipe, a stainless steel pipe, or a thin-walled plastic pipe. The copper pipe, stainless steel pipe, or thin-walled plastic pipe has an excellent heat transfer performance, facilitating the heat exchange between the evaporation pipe 200 and the indoor air, and increasing the refrigeration effect.

Referring to FIG. 1, in some embodiments, a top of the second water tank 430 is provided with a shading tent 434 to avoid direct solar radiation and to prevent influencing the temperature lowering effect of water due to an excessive high water temperature in the second water tank 430.

Referring to FIG. 1, in some embodiments, the input end of the water inlet pipe 300 is connected to a third switch valve 320, facilitating the control over inlet water speed of the evaporation pipe 200. Meanwhile, the third switch valve 320 cooperates with the second switch valve 423, so as to form a sealing ring space in the evaporation pipe 200. The third switch valve 320 and the second switch valve 423 may be turned off before mounting, so as to facilitate extraction of air in the evaporation pipe 200 from the three-way valve 310 to form vacuum.

Referring to FIG. 1, in some embodiments, the water inlet pipe 300 is connected to a U-shaped bent pipe 330, and the U-shaped bent pipe 330 is located at a lower side of the water inlet pipe 300. The U-shaped bent pipe 330 is deposited with the liquid water to form water sealing, which can prevent hydrogen in the evaporation pipe 200 from escaping.

The embodiments of the present disclosure are explained in detail by combining with the accompanying drawings above. However, the present disclosure is not limited to the embodiments above, various changes may be made within the range of knowledge mastered by a person of ordinary skill in the art without departing from gist of the present disclosure.

What is claimed is:

1. An open-type ceiling refrigeration system, comprising:
a ceiling;
an evaporation pipe fixedly connected to the ceiling and slantly arranged, an input end of the evaporation pipe being higher than an output end of the evaporation pipe;
a water inlet pipe disposed outside the ceiling, an output end of the water inlet pipe being connected to the input end of the evaporation pipe, and the water inlet pipe being connected to a three-way valve; and
a water removal assembly disposed outside the ceiling and below the evaporation pipe, the water removal assembly comprising a water sealing cavity, the output end of the evaporation pipe being connected to the water sealing cavity by means of a recovery pipe, the water sealing cavity being connected to a first pipeline extending upwards and communicated with the input end of the evaporation pipe, a lower end of the first pipeline being connected to a molecular sieve configured for limiting water vapor from passing through, and the water removal assembly being configured for absorbing the water vapor.

2. The open-type ceiling refrigeration system of claim 1, wherein an inclined angle of the input end of the evaporation pipe towards the output end of the evaporation pipe is 2° to 10°.

3. The open-type ceiling refrigeration system of claim 1, wherein a water absorption fiber is disposed in the evaporation pipe.

4. The open-type ceiling refrigeration system of claim 1, wherein the evaporation pipe is an S-shaped bent pipe.

5. The open-type ceiling refrigeration system of claim 1, wherein the evaporation pipe is a copper pipe, a stainless steel pipe, or a thin-walled plastic pipe.

6. The open-type ceiling refrigeration system of claim 1, wherein the water removal assembly comprises a first water tank and a second water tank placed in the second water tank, the second water tank has an upper opening, the second water tank is connected to an input end of the water inlet pipe by means of a third pipeline, the third pipeline is connected to a first switch valve, a lower end of the first water tank is provided with a lower opening communicating the first water tank with the second water tank, the lower opening is connected to a second switch valve, and the first water tank has a water sealing cavity.

7. The open-type ceiling refrigeration system of claim 6, wherein a top of the second water tank is provided with a shading tent.

8. The open-type ceiling refrigeration system of claim 1, wherein an input end of the water inlet pipe is connected to a third switch valve.

9. The open-type ceiling refrigeration system of claim 1, wherein the water inlet pipe is connected to a U-shaped bent pipe, and the U-shaped bent pipe is located at a lower side of the water inlet pipe.

10. The open-type ceiling refrigeration system of claim 1, wherein the open-type ceiling refrigeration system further comprises a hydrogen production means; the hydrogen production means comprises a third water tank, an anode block, a cathode block, a collection cover, and an external DC power source; the third water tank stores a hydrogen production electrolyte; the anode block and the cathode block are disposed in the third water tank at an interval; the anode block is connected to a positive pole of the external DC power source; the cathode block is connected to a negative pole of the external DC power source; the collection cover is configured to cover above the cathode block; the collection cover is connected to the water sealing cavity by means of a second pipeline; and the second pipeline is provided with a fourth switch valve.
